(19) United States
(12) Patent Application Publication
(10) Pub. No.: US 2006/0164397 A1
(43) Pub. Date: Jul. 27, 2006

(54) Appliance with membrane overlay

(75) Inventors: Jordan S. Bruntz, Baxter, IA (US); Kirk M. Dunsbergen, Newton, IA (US); S. Luke Bullock, Ankeny, IA (US)

Correspondence Address: MCKEE, VOORHEES & SEASE, P.L.C.;ATTN: MAYTAG/ WHIRLPOOL, 801 GRAND AVENUE, SUITE 3200, DES MOINES, IA, 50309-2721, US

(73) Assignee: Maytag Corporation, Newton, IA (US)

(21) Appl. No.: 11/045,641

(22) Filed: Jan. 27, 2005

(51) Int. Cl. G09G 5/00

(52) U.S. Cl. 345/172

(57) ABSTRACT

An appliance includes a console, a control member attached to the console manually shiftable to selectively establish a desired setting for the appliance, and a membrane overlay upon the console having at least one embedded indicator light for indicating the desired setting, at least one embedded switch to activate a special cycle for the appliance, or a combination of indicator light and embedded switch. The membrane overlay and the control member each having a ribbon cable that extends into the console to attach to a control board. User feedback of the selected setting of the control member is provided through the illuminated indicator around the perimeter of the control member.

### BACKGROUND OF THE INVENTION

The present invention pertains to the art of appliances including laundry, dishwashing, cooking, and refrigeration appliances. More specifically, the present invention pertains to the incorporation of a membrane display overlay in appliances.

In an appliance, such as a clothes washer or dryer, it is necessary for a consumer to establish a certain operating cycle, as well as a desired operating time for the cycle. For example, in a washing machine, either before or after loading a tub of a machine with clothes to be laundered, the user must establish both a desired cycle and establish an operating time for the cycle. Typically, a rotatable control knob is provided with graphic symbols around the knob to signify different, selectable cycles.

For example, a conventional washing machine may incorporate a knob which can rotate through 360° for use in selecting between the washing of whites, delicates, or colors. The knob would have associated therewith an indicator which generally functions as a pointer to provide feedback of the selected operation to the user. The time needed to perform the selected operation depends on the positioning of a knob within a given cycle range. For example, the consumer can set the application to perform a light, normal or heavy washing operation, with each of these settings functioning to establish the length of time needed to perform the selected washing cycle. Additionally, the consumer could simply select a rinse mode, along with the time for the rinse mode.

In such a commonly known cycle and time setting arrangement utilizing a rotatable control knob, the knob can only be rotated in one direction. As the cycle for whites, delicates and colors are sequentially arranged about the knob, the knob often has to be rotated through a significant angular range to reach a desired position. In addition, since the knob can only be rotated in one direction, if the user even slightly over-rotates the knob, the user must then rotate the knob through slightly less than 360° to finally reach the desired setting. Obviously, this overall control setting arrangement is quite inefficient.

A similar rotatable control knob arrangement for use in selecting both cycle and operating times can also be found in many clothes dryers. That is, it is known to provide a rotatable knob on a clothes dryer wherein the knob is used to select both the drying cycle, generally based on the type of clothes article to be dried, and the drying time. Therefore, the same type of disadvantages discussed above with respect to the known washing machine control arrangements can also pertain to clothes dryers. In any event, there exists a need in the art of laundry appliances for an improved operating cycle and time setting control device wherein operation cycles and times can be easily and efficiently established.

Additionally, control knobs for washers and dryers in the prior art often incorporate a mechanical timer with the rotatable control knob such that it rotates through both the operation cycle and time settings. The control system may be improved upon by replacement of the mechanical timer with a rotary encoder which translates the position of the knob into a specific cycle selection and controls the cycle through a program executed by an intelligent controller.

A rotatable control knob arrangement provides feedback to the user often by including an arrow or marking on the outer rim of the knob that indicates the cycle and time position of the cycle (rinse, spin, off, etc.). The use of the rotary encoder does not typically use a mechanical timer and thus a display may be used to replace the traditional timer. The display may be an LED (light emitting diode) or other indicator light. Additionally, separate indicator lights may be used for the cycle selection and the time/mode setting.

Indicator lights have been used in the prior art but in most instances LEDs are attached to a control board and must be placed in line with light channeling or piping. The use of LEDs with light channels creates problems because the indicator lights must be inserted into the channels or aligned with light pipes. Additionally, this aligning creates a risk of board damage as board mounted LED's are more susceptible to breaking or bending during shipping or assembly. Furthermore, there is a concern for water entering the console through the light channel and creates a need for seal between a fascia of the control panel and the inserted light-channeling component. Therefore, an objective of the present invention is to utilize an improved indicator light arrangement such as one on a membrane overlay.

A further objective of the present invention is to eliminate unused indicator lights. With board mounted indicator lights, only some indicator lights would be used depending on the feature set and the unused indicator lights would be covered up with an overlay. Thus, an objective of the present invention is to provide only the required number of LED's for the specific model to therefore eliminate unused LED's.

Another problem associated with prior art laundry appliances is that service technicians do not have the ability to select special cycles necessary for troubleshooting the appliance. Therefore, an objective of the present invention is to include switches upon a membrane overlay that could activate special cycles such as continuous run, advertising mode, functional test, or to turn on diagnostic modes for service.

Another problem with the prior art is that it may require two control boards, one for the encoder and LED's and the other for the power and relay components, two control boards may be large in size. Therefore, an objective of the present invention is to reduce the board size and/or the need for two boards. This objective may be achieved by eliminating the LED's on the control board and all the required traces for the LED's from the encoder board and then combining the two boards into one.

Other similar problems may be readily identified with regards to dishwashing, cooking, and refrigeration appliances.

These and other objectives will become evident after review of the specification and drawings.

### BRIEF SUMMARY OF THE INVENTION

The foregoing objectives may be achieved using an appliance having a console, a control member attached to the console manually shiftable through a predetermined range of travel for selecting a desired cycle, a membrane overlay upon the console having at least one embedded light indicating the desired cycle. According to another feature of the present invention the control member may be a rotary encoder.

A further feature of the present invention is a fascia (i.e. front face) upon the console that is designed to have a hollow with a back face and side edge that receives the membrane overlay. The membrane overlay may be approximately flush with the console fascia and/or provide a water resistant seal with the fascia to prevent water from entering the hollow.

A further feature of the present invention is the positioning of the membrane overlay around the control member and/or adjacent the control member.

A further feature of the present invention is a variety of control members that may be used with the membrane overlay including the rotary encoder, a rotary mechanical switch, a slider switch, a button array, etc.

A further feature of the present invention is the provision of a control board that may receive a ribbon cable from the control member and/or the membrane overlay.

A further feature of the present invention is the inclusion of an intelligent controller that receives input from the control member and controls illumination of the indicator light.

A further feature of the present invention is at least one embedded switch within the membrane overlay that may activate special cycles (continuous run, advertising mode, functional test, diagnostic modes for service, etc.).

The foregoing objectives may also be achieved utilizing a console with a control member that is moveable to select a desired cycle and a membrane overlay upon the console having at least one embedded switch to activate a special cycle. The appliance may additionally have a plurality of embedded indicator lights that may be used to display a desired cycle and/or a cycle status.

The foregoing objectives may also be achieved with a method of assembling a console including fitting the membrane overlay into a hollow of the console and placing a ribbon cable leading from the membrane overlay upon the control board and fitting the rotary encoder within an opening of the membrane and placing a ribbon cable from the rotary encoder upon the control board.

### BRIEF DESCRIPTION OF THE DRAWINGS

FIG. 1 is a front perspective view of a top loading washing machine incorporating the control member and membrane overlay.

FIG. 2 is a front view of the console of the appliance utilizing the membrane overlay and control member.

FIG. 3 is a rear exploded view of the top of the appliance clearly illustrating the encoder switch.

FIG. 4 is a rear, perspective exploded view of the top of the appliance showing the membrane overlay ribbon cable, rotary encoder ribbon cable, and control board.

FIG. 5 is an assembled view of the appliance console with the membrane overlay ribbon cable and the rotary encoder ribbon cable attached to the control board.

FIG. 6 is a partially exploded view of the membrane overlay in position over a hollow of the control panel with an encoder knob center positioned over the membrane overlay.

FIG. 7 is similar to FIG. 6 but additionally includes membrane switches upon

### DETAILED DESCRIPTION OF THE PREFERRED EMBODIMENT

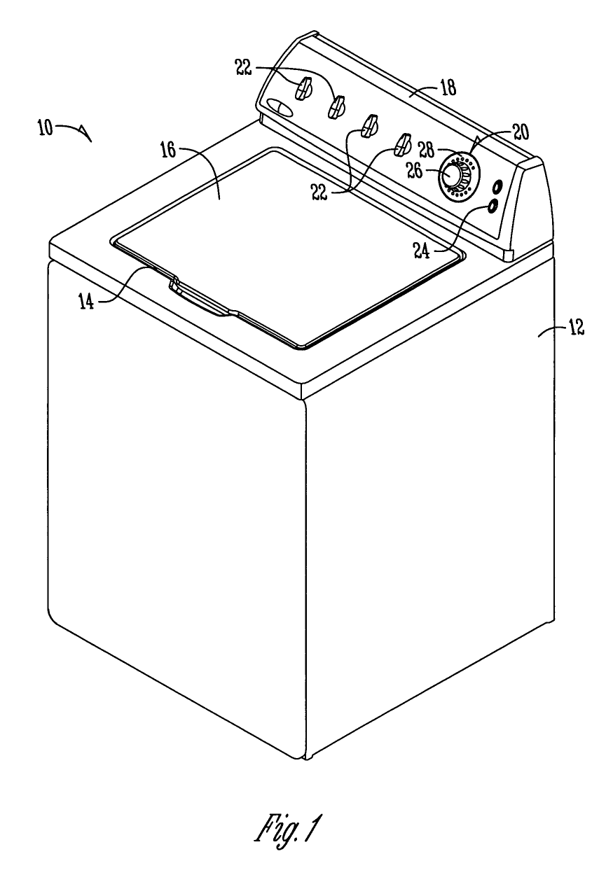

With initial reference to FIG. 1, a laundry appliance constructed in accordance with the present invention is generally indicated at numeral 10. For exemplary purposes, laundry appliance 10 is shown to be constituted by a clothes washer. However, as will become more fully evident below, the invention is also applicable to clothes dryers as well as dishwashing, cooking, and refrigeration appliances.

As shown, laundry appliance 10 includes an outer cabinet 12 provided with an access opening 14 that can be selectively closed by means of a pivotable lid 16. In a manner widely known in the art, the lid 16 can be raised providing access to a rotatable basket (not shown) within the cabinet 12, with clothes to be laundered being adapted to be placed in the basket. It should be understood that the lid or door 16 may optionally be on the front of the cabinet 12 as in the case of a front loading laundry appliance.

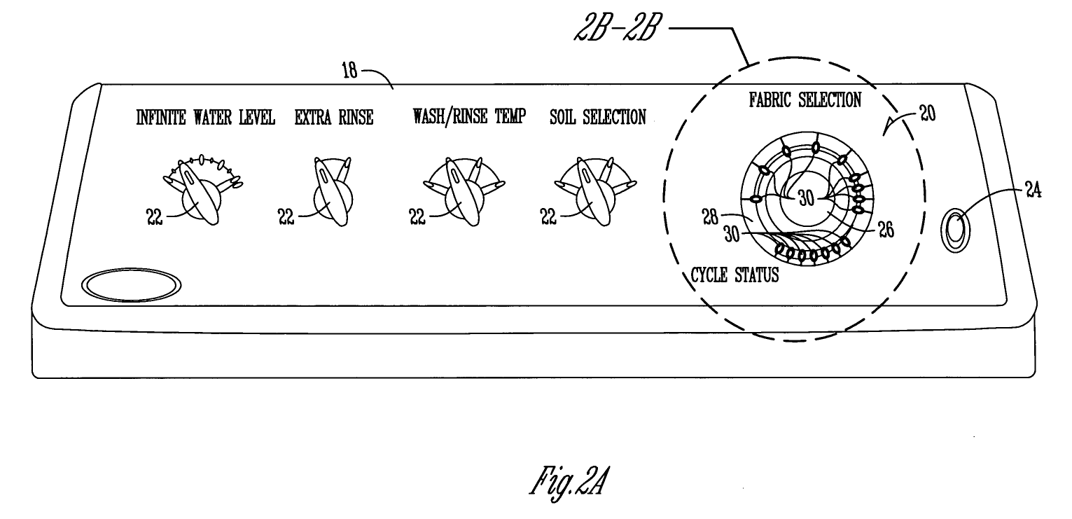

At a rear portion of cabinet 12 is arranged a control panel 18 that includes various control units which can be used to program the desired laundering operations for appliance 10. As seen in FIG. 2, the control panel 18 has a primary control member 20 that permits selection of a desired cycle including quick wash, spin only, rinse and spin, power off and fabric selection corresponding to different cycles for example hand wash (gentle/slow), delicates (gentle/slow), perm press (medium/slow), regular (medium/fast). The control panel 18 also has secondary control knobs 22 that are used to select water level, extra rinse, wash/rinse temp, and soil selection. The control panel 18 may also have optional switches 24 such as one that might control whether or not an audio signal may be turned on or off.

As further seen in FIG. 2, the primary control member 20 has a rotatable knob 26 and a membrane overlay 28. The membrane overlay 28 may have a series of illuminating members 30 embedded in the membrane. The illuminating members 30 may be used to indicate the desired cycle/fabric selection and/or the cycle status. Additionally, the membrane overlay replaces the prior art board mounted LED's and eliminates the challenge of aligning multiple components, namely switch support, fascia, control boards, and light channeling components. Additionally, a reduction of components is achieved with a membrane overlay because light-channeling devices would not be required.

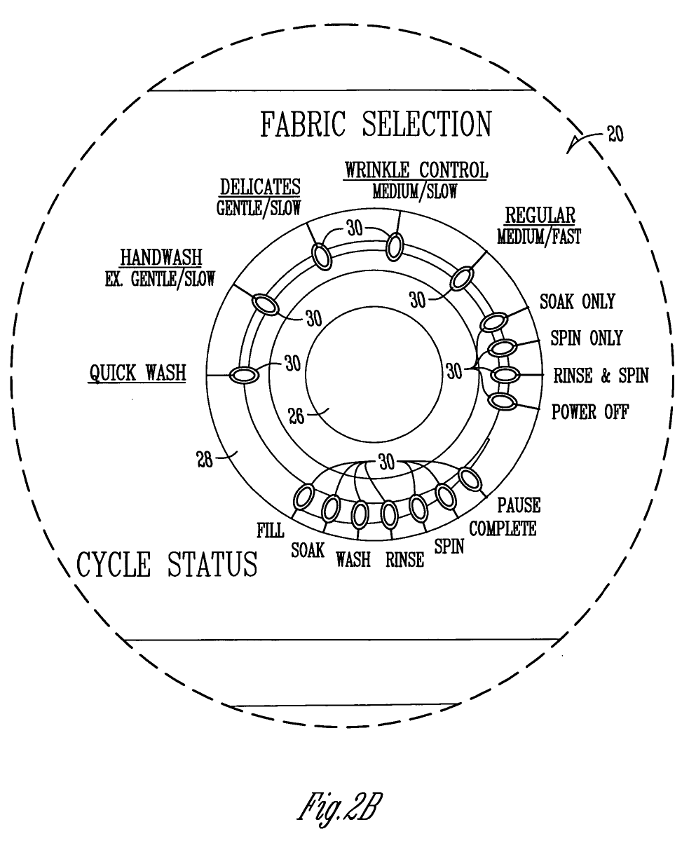

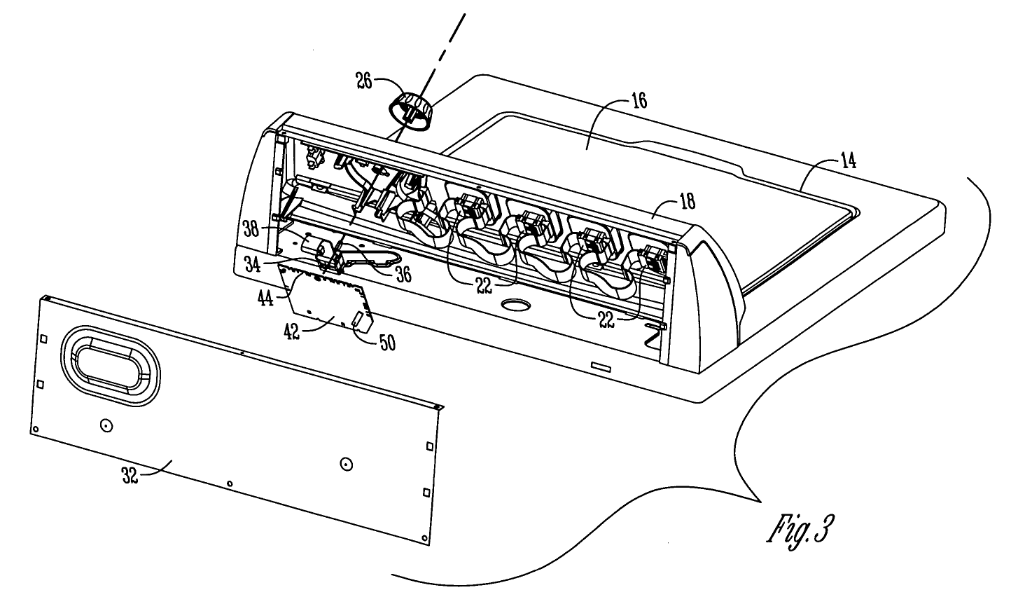

As seen in FIG. 3, the console 18 has a back panel 32 that may be removed to expose the inside of the console 18. The rotatable member or knob 26 is positioned upon a switch 34. The switch 34 has a shaft 36 which the knob 26 attaches to. The switch 34 may be an encoder switch. The switch 34 is manually shiftable through a predetermined range of motion to establish a desired setting. The switch 34 may travel 360° but is more likely to travel less than 360° but rotate interchangeably in opposite directions. Additionally, the switch 34 may be an encoder switch with a ribbon cable 38 that ends in a plug 40 (FIG. 4) that may attach to control board 42 specifically to an edge 44 of the control board. An intelligent controller or computer may be connected to the control board 42 to receive input from the control member 20 and control illumination of the indicator lights 30.

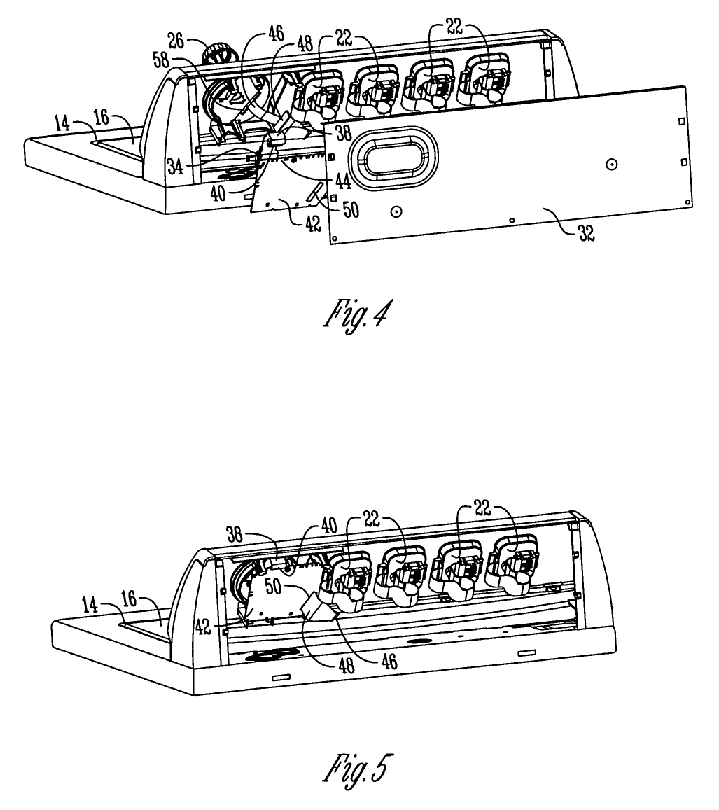

FIG. 4 illustrates a membrane overlay 28 in place upon the console 18 having a membrane overlay ribbon cable 46 extending through an opening 58 of the console and ending in a plug 48. As seen most clearly in FIG. 5, the membrane overlay plug 48 engages a header 50 of the control board 42.

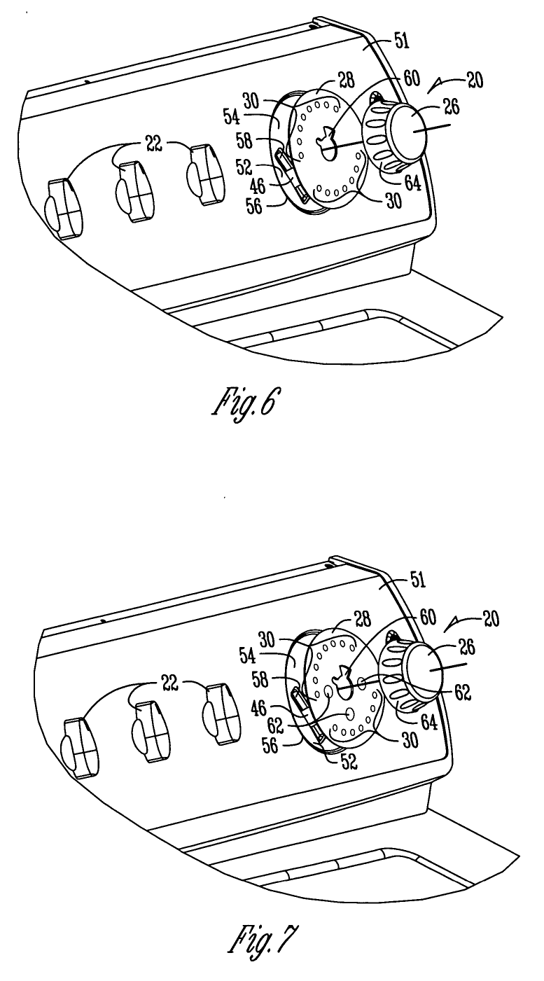

As seen in FIG. 6, the membrane overlay 28 sits within the console 18. Specifically, the console has a fascia 51 with a defined hollow 52 with a back face 54 and side edge 56. An opening 58 is provided in the back face 54 of the hollow 52 to permit the ribbon cable 46 to extend there through. The membrane overlay 28 also has an opening 60 to permit the shaft 36 to be placed there through.

As seen in FIG. 7, membrane switches 62 may also be included with the membrane overlay. Alternatively, the membrane switches 62 may be used without illuminating members 30.

The switches 62 may reside underneath an outer skirt 64 of the knob 26 to be hidden from the consumer but providing easy access for a technician.

During assembly, the membrane overlay 28 is fit in the hollow 52. A front face of the membrane overlay 28 may be approximately flush (i.e. within the same plane) with the fascia 51 and form a water resistant seal with the fascia. The switch 34 is in alignment with the opening 60 such that it may receive the knob 26. Both the membrane overlay 28 and the switch 34 are then electrically connected to a control board 42 via respective ribbon cables 46 and 38.

Although described with respect to a preferred embodiment of the invention, it should be readily understood that various changes and/or modifications can be made to the invention without departing from the spirit thereof. For instance, although the knob 26 is depicted as a rotatable member, it may be a slide switch, a button array, a rotary controller, etc. Also, although the knob 26 is depicted within the center of the membrane overlay it may be off-centered. Additionally, although the member overlay is depicted surrounding a control member 26, it may surround only a portion of a control member or be off to the side of the control member. In addition, such a control member and member overlay arrangement could be employed for use in connection with other parameters needing to be set for the appliance 10 such as water level, extra rinse, wash/rinse temp, those more particularly associated with dishwashing, cooking, and refrigeration appliances, etc. In any event, the invention is only intended to be limited by the scope of the following claims.

What is claimed is:

1. An appliance comprising:
a cabinet including an access opening;
a lid, pivotally attached to the cabinet;
a console attached to the cabinet;
a control member attached to the console manually shiftable through a predetermined range of travel adapted to selectively establish a desired setting;
a membrane overlay upon the console having at least one embedded indicator light adapted to indicate the desired setting.

2. The appliance of claim 1 wherein the control member is a rotary encoder.

3. The appliance of claim 1 wherein the membrane overlay is positioned around the control member.

4. The appliance of claim 2 wherein the console has a fascia, a hollow upon the fascia with a back face and side edge, and the membrane overlay lies within the hollow.

5. The appliance of claim 4 wherein the membrane overlay has a front face that is approximately flush with the console.

6. The appliance of claim 4 wherein the membrane overlay creates a water resistant seal with the fascia.

7. The appliance of claim 1 wherein the membrane overlay is positioned adjacent the control member.

8. The appliance of claim 1 wherein the control member is a slider switch.

9. The appliance of claim 1 wherein the control member is a button array.

10. The appliance of claim 1 wherein the control member is a rotary controller.

11. The appliance of claim 1 further comprising a control board in communication with both the control member and the membrane overlay.

12. The appliance of claim 11 further comprising an intelligent controller receiving input from the control member and controlling illumination of the indicator light.

13. The appliance of claim 1 wherein the membrane overlay includes at least one embedded switch adapted to activate a special cycle.

14. The appliance of claim 13 wherein the control member has a removable knob with an outer skirt, the embedded switch located beneath the outer skirt.

15. An appliance comprising:
a cabinet including an access opening;
a lid pivotally attached to the cabinet;
a console attached to the cabinet;
a control member attached to the console manually shiftable to selectively establish a desired setting for the appliance;
a membrane overlay upon the console having at least one embedded switch adapted to activate a special cycle.

16. The appliance of claim 15 wherein the control member has a rotatable knob.

17. The appliance of claim 16 wherein the knob has an outer skirt, the embedded switch located beneath the outer skirt.

18. The appliance of claim 16 wherein the membrane overlay has a plurality of embedded indicator lights.

19. The appliance of claim 18 wherein at least one of the embedded indicator lights illuminates to display a desired cycle.

20. The appliance of claim 18 wherein at least one of the embedded indicator lights illuminates to display a cycle status.

21. The method of assembling a console of an appliance comprising:
providing a console having a fascia with a hollow;
providing a rotary encoder having a first wire ending in a first plug;
providing a membrane overlay having at least one of either an embedded indicator light or an embedded switch, the membrane overlay having a second wire ending in a second plug, the membrane overlay having an opening for the rotary encoder;
providing a control board leading to an intelligent controller having a first connector and a second connector;
fitting the membrane overlay into the hollow and placing the second plug in position upon the second connector;
fitting the rotary encoder within the opening of the membrane and placing the first plug in position upon the first connector.
